(19) United States
(12) Patent Application Publication
(10) Pub. No.: US 2003/0066050 A1
(43) Pub. Date: Apr. 3, 2003

(54) Method and system for programming devices using finite state machine descriptions

(76) Inventors: Douglas W. Wang, Lake Forest, CA (US); Sudhir Dattacam Kadkade, Lake Oswego, OR (US); Clifton Alton Lyons JR., Lake Oswego, OR (US)

Correspondence Address: ROSENBERG, KLEIN & LEE, 3458 ELLICOTT CENTER DRIVE-SUITE 101, ELLICOTT CITY, MD, 21043, US

(21) Appl. No.: 09/962,232

(22) Filed: Sep. 26, 2001

(51) Int. Cl. G06F 9/44

(52) U.S. Cl. 717/105

(57) ABSTRACT

A method and system for capturing a Finite State Machine (FSM) description of the desired behavior of a device, and converting that description into a program that is executable by the device. In the preferred embodiment, the device is a programmable robot toy. The user enters an FSM description of the desired behavior of the robot toy using a graphical user interface running on a personal computer. When requested, the preferred embodiment compiles the FSM description into a program executable by a virtual machine running on a micro-controller inside the robot toy. This program is sent to the toy via an infrared transmitter and infrared receiver, and stored in the toy's memory. Then, when the robot toy is used, the virtual machine executes the stored program so that the toy behaves as specified by the FSM description.

### BACKGROUND OF THE INVENTION

(1) Field of the Invention

The invention relates generally to control programming and, more specifically, to an improved method and system for creating device control programs.

(2) Description of the Prior Art

Active toys, i.e. toys that move, make sounds, etc., are very popular. The wider the variety of behaviors an active toy is capable of, the more interesting it will be and the more revenue it will generate for the company marketing the toy. Toy companies can increase the behavioral variety of a toy by adding more types of atomic actions (such as particular arm movements), but this increases the complexity of the toy and thus its manufacturing cost. Besides, once a reasonable number of atomic actions are provided for a given type of toy, adding more atomic actions yields rapidly diminishing returns—the increase in play value achieved by adding more atomic actions becomes too small to justify the cost.

A cheaper and more effective way to increase the behavioral repertoire of an active toy is to combine the existing atomic actions in a wider variety of ways. (For example, a relatively limited set of notes can be combined in many different ways to yield a large number of different songs.) To achieve this, active toys are usually built with a micro-controller that can be programmed to carry out a complex sequence of atomic actions.

Many active toys today are sold with a single, fixed program “hardwired” into the toy. However, toy designers have recognized the potential to increase the play value and popularity of their active toys by making them reprogrammable. For example, a single robot could be used in a variety of different play scenarios by reprogramming it with different identities (cowboy, soldier, fireman, etc.). Several different approaches to providing reprogrammability are in use today.

One common way of making an active toy reprogrammable is to use the “fixed menu” approach. The toy company creates several different programs for the toy, and makes them available in any of several ways (downloads on a web site, plastic disks sold in retail stores, etc.). The child selects a program from the set of available alternatives, and loads it into the toy. This can be done in a variety of ways, as has been shown in the teachings of several prior art patents. For example, a toy can be designed so that a child can download a program from a web site to his PC, and from there send the program to the toy over an infrared link or over a USB link. The limitation of the “fixed menu” approach is not in the mechanics of loading a program into a toy. Rather, the limitation is in the number and variety of programs that the toy company can afford to create. Given the sales volumes and gross margins that are typical in the toy business, toy companies cannot afford to create a broad variety of programs for each of their active toys. This limits the potential play value of each toy. Furthermore, since the “fixed menu” approach restricts children to pre-built programs, they cannot exercise their creativity to make new and interesting programs of their own.

Ideally, a child buying a reprogrammable active toy would be provided with a means of creating his own programs for the toy. However, the methods usually used to create programs for micro-controllers require programming skills in assembly or in a higher-level language such as Basic or ‘C’. Only a small percentage of adults are able to create programs in this manner, and almost no children can. Therefore it is necessary to provide a simpler, more intuitive way for children to create programs.

Several approaches to the problem of enabling children to create programs have been tried. One approach is to provide a keypad attached to the toy that a child can use to enter a sequence of desired actions. This sequence is then saved in the toy as a program. Experience in other fields has shown that such techniques are only practical for trivially short, simple programs. Even modest-size programs need to be developed iteratively. For a child, this means that a draft program needs to be visually presented in such a way that he can easily understand how it works. It also needs to be easy for him to change the program to fix problems or to add new behavior. Finally, it needs to be quick and easy for the child to try the improved program to see if he likes it. Keypad entry, which has no graphical program display and which requires the entire program to be re-entered every time a change is made, does not meet any of these three requirements. Some companies have tried to improve on the keypad entry approach by providing a small display screen with the keypad. However, cost constraints require the screen to be so small that the increase in the size of the program that can practically be created by a child is minimal. Therefore, the state of the art is to exploit the capability of personal computer (PC) to meet the requirements. Not only are personal computers far more powerful and easier to use than a keypad (with or without a small screen), they also have good market penetration in families that would buy a programmable toy, and most children in those families are already familiar with using a PC.

A few different approaches to using a PC for toy programming have been tried. One approach is to both create and run the program on the PC. While the child is playing with the toy, the PC acts as the “brains” of the toy, and sends a control message to the toy each time the toy is supposed to do something. This requires the PC to be in continuous communication with the toy, i.e. the toy doesn't work without the PC. Such a restriction is acceptable for something like a model train set, which is used in a fixed location for an extended period of time. However, this restriction is not acceptable for most toys, because children want to be able to play with their toys away from their PC. Besides, the “PC as central controller” approach leads to problems when children want to play with several toys of the same kind. Unless the children want all of their toys to be doing exactly the same thing at exactly the same time, the central controller PC needs to distinguish among the toys that are in range and send out individualized command sequences for each. Likewise, each toy needs to be able to distinguish among the various command sequences that the PC broadcasts, obeying commands meant for it and ignoring commands meant for the other toys in range. Technically it is possible to do this, but it adds to the complexity and cost of the product.

The limitations of the “PC as central controller” approach can be avoided by using a “distributed control” approach. In this method the power of the PC is used to create the program, but not to run the program. Instead, the program is compiled and downloaded from the PC to the toy, and the toy runs the program itself. This allows the child to play with the toy anywhere, without needing to be in range of the PC. It also allows children to play with several toys of the same kind at the same time without requiring complex multi-toy control technology.

Several child-programmable toys have been designed using the distributed control approach. While some of them offer graphical programming with artwork that is quite visually appealing, they all require the child to create programs at a fairly low level. The programs basically consist of a series of steps (e.g. walk forward 10 cm., turn left 90 degrees, beep twice, walk forward 5 cm., . . . ) and “if X happens, then do Y” directives. There is no high-level conceptual framework for these programs, so it is difficult for a child to understand a program of any reasonable size that is written in this manner.

High-level conceptual frameworks make it much easier for people to create and understand programs. Their advantages have motivated extensive efforts to develop conceptual frameworks for creating programs in many different fields. For example, in the field of automated industrial process control, the “data flow diagram” conceptual framework has made it much easier for people to create and understand process control programs. A high-level conceptual framework that is intuitive enough to enable people without a technical background in software engineering or in hardware control to program devices would have many applications. Not only toys, but also climate control systems, cleaning robots, lighting control systems, television-program recorders, landscape sprinkler systems, and numerous other devices could be successfully programmed by their users instead of just by their manufacturers. As progress in embedded control, robotics and other fields increases the capabilities of devices, there will be increasing demand for an easy way to program these devices to satisfy the individual needs and interests of each user. It is an object of the present invention to provide a means of creating device-control programs using a conceptual framework that meets this demand.

### SUMMARY OF THE INVENTION

The present invention comprises a system and method for capturing a Finite State Machine (FSM) description of desired behavior of a device, and compiling or otherwise converting that description into a program that is executable by the device. FSM descriptions have been defined and discussed in numerous publications, such as the Addison-Wesley book Introduction to Automata Theory, Languages and Computation, by John E. Hopcroft and Jeffrey D. Ullman. The FSM paradigm is a proven conceptual framework for organizing the details of a complex behavioral description in a modular, easy to understand form. The invention thus provides a method and apparatus for programming a device using a Finite State Machine (FSM) description of the desired behavior of the device.

The method includes the step of executing a user interface program (UI) on a computer, which displays a plurality of graphic objects on a display and captures user input, thereby enabling the user to specify the FSM. This step shall be referred to below as the Input Step.

The Input Step includes enabling the user to specify the desired states of the FSM (States). Each State corresponds to a particular state of the device as envisioned by the user. For example, in the case of a toy robot, the user may define a “Happy” state, a “Scared” state, an “Angry” state, etc. States are not limited to imaginary emotional states; they can correspond to any concept or situation that is of interest to the user. In other words, the user may create any States he wants (up to a numerical limit determined by the memory and other program resources available in the device). One State must be designated as the “Start State”, which specifies which State the device will enter when it begins running the program. The invention contemplates that the UI may enable the user to create States in any of a variety of ways. User interface techniques to create a new object (such as a State) and to set the object's properties (such as the State's name) are well known to those skilled in the art. In the preferred embodiment, the UI displays a “New State” button. When the user selects this button, a new State is created. A dialog box enables the user to set the name of the State, and to assign it an icon that may help remind the user of the concept he had in mind when he created the State.

The Input Step also includes enabling the user to specify the desired transitions of the FSM (Transitions). Each Transition specification includes a Current State, a Next State, and a Trigger, where the Current State is a State, where the Next State is a State, and where the Trigger is an event whose occurrence can be detected. The Transition specification means that if the Transition's Trigger event is detected while the FSM is in the Transition's Current State, then the FSM will leave the Transition's Current State and enter the Transitions's Next State. The invention contemplates that the UI may enable the user to create Transitions in any of a variety of ways. Essentially the UI must enable the User to specify a triplet, where each element of the triplet is to be chosen from some set of possibilities for that element. User interface techniques to do this are well known to those skilled in the art. In the preferred embodiment, the UI enables the user to specify which State he is currently working on. Then the UI displays a plurality of graphic objects, one for each possible Trigger. When the user selects one of the graphic objects that corresponds to a Trigger, a Transition is created using that Trigger. The Current State of the Transition is the State the user is currently working on, and the Next State of the Transition is selectable by the user from a list of all of the States.

The Input Step also includes enabling the user to specify sequences of Actions that he wishes the device to perform (Action Sequences). An Action can be any device behavior that the device designer has chosen to make programmatically available to the user. For example, in the case of a toy robot, an Action can be moving forward, turning around, saying a word, etc. An Action can also be a control construct, such as “if . . . then . . . ” or “while . . . do . . . ”, which enables the user to control how the sequence is executed. The invention contemplates that the UI may enable the user to specify an Action Sequence in any of a variety of ways. Essentially the UI must enable the user to specify an ordered list, where each element of the list is to be chosen from a set of possible elements. User interface techniques to do this are well known to those skilled in the art. In the preferred embodiment, the UI displays a plurality of graphic objects, one for each possible Action. The user is enabled to select one of the objects, thereby creating an instance of the corresponding Action which is displayed as a new graphic object. The user is enabled to drag this new graphic object into an ordered list of Action instance graphic objects. Then the user is enabled to set any properties that can be used to customize the Action, such as duration.

The Input Step also includes enabling the user to associate each Action Sequence with a State or a Transition. The invention contemplates that, depending on the resource constraints of each device, the target market for the device, and various other considerations, a particular embodiment may allow the user to associate Action Sequences only with States, only with Transitions, or with both States and Transitions. If an Action Sequence is associated with a State, it means that the Action Sequence will begin to execute whenever the FSM enters that State. If the FSM leaves that State before the Action Sequence is completed, the Action Sequence will be halted. If an Action Sequence is associated with a Transition, it means that whenever the Transition occurs, the Action Sequence will begin after the FSM leaves the Transition's Current State, and will complete before the FSM enters the Transition's Next State. The invention contemplates that the UI may enable the user to associate an Action Sequence with a State or with a Transition in any of a variety of ways. Essentially the UI must enable the user to link an object of a particular type (a State or a Transition) to an object of another particular type (an Action Sequence). User interface techniques to do this are well known to those skilled in the art. In the preferred embodiment, the UI only allows Action Sequences to be associated with States. The association between a particular Action Sequence and a particular State is achieved by enabling the construction or modification of an Action Sequence only when the user has chosen the associated State as his working context.

The Input Step also includes enabling the user to view the FSM. This has several advantages for a typical user who will be using the iterative development approach, including making it easier for the user to understand the FSM and making it easier for him to determine how to change the FSM to improve the programmed behavior of the device. The invention contemplates that the UI may enable the user to view the FSM in any of a variety of ways. Those skilled in the art of hardware control programming will be familiar with several techniques for displaying an FSM, including a state-transition table and a state-transition diagram. In the preferred embodiment, the UI displays the FSM using a state-transition diagram.

A further step of the method is compiling the FSM into a program that is executable by the device. The invention contemplates that this step may be done in any of a variety of ways. Those skilled in the art of compiler design will be familiar with several implementation techniques that are suitable for carrying out this step. In the preferred embodiment, the FSM is compiled to a set of instructions and jump tables that can be read and executed by a virtual machine that runs on the device's micro-controller.

A further step of the method is sending the compiled program to the device. The invention contemplates that this step may be done in any of a variety of ways. Those skilled in the art of data transfer will be familiar with several implementation techniques that are suitable for carrying out this step, including physical media transfers (e.g. floppy disks), wireless transfers (e.g. Bluetooth) and wired transfers (e.g. 10 BaseT Ethernet). In the preferred embodiment, the compiled program is sent through the serial port of a personal computer to an infrared transmitter. The transmitter emits an infrared signal containing the program, which is received by an infrared sensor on the device. The program is then stored in the device for later execution.

### BRIEF DESCRIPTION OF THE DRAWINGS

FIG. 1 is a schematic block diagram illustrating the principal hardware components of the preferred embodiment: a personal computer connected to an infrared transmitter via a serial cable, and an Intelliboy robot modified to include an infrared receiver and a micro-controller.

FIG. 2 illustrates an exemplary display screen for the preferred embodiment's User Interface in “edit the FSM” mode, showing a State, the State's Action Sequence, the State's Event-Triggered Transition List, and the menus and buttons available for the user to modify this State and perform other tasks.

FIG. 3 illustrates an exemplary display screen for the preferred embodiment's User Interface in “view the State Diagram” mode, showing a drawing of the States and Transitions in an FSM.

FIG. 4 is a schematic block diagram illustrating the data structures used by the preferred embodiment's User Interface to store State information.

FIG. 5 is a schematic block diagram illustrating the data structures used by the preferred embodiment's User Interface to store Action Instance information.

FIG. 6 is a schematic block diagram illustrating the data structures used by the preferred embodiment's User Interface to store Event-Triggered Transition Instance information.

FIG. 7 is a schematic block diagram illustrating the State Action Records Sections in the Compiler Input File created by the preferred embodiment's User Interface.

FIG. 8 is a schematic block diagram illustrating the Timer Transition Records Section in the Compiler Input File created by the preferred embodiment's User Interface.

FIG. 9 is a schematic block diagram illustrating the Non-Timer Transition Records Section in the Compiler Input File created by the preferred embodiment's User Interface.

FIG. 10 is a schematic block diagram illustrating the State Action Sections in the Compiled Program Description File created by the preferred embodiment's Compiler.

FIG. 11 is a schematic block diagram illustrating the Timer Transition Section in the Compiled Program Description File created by the preferred embodiment's Compiler.

FIG. 12 is a schematic block diagram illustrating the Non-Timer Transition Section in the Compiled Program Description File created by the preferred embodiment's Compiler.

FIG. 13 is a schematic block diagram illustrating part of the preferred embodiment's micro-controller memory in which the preferred embodiment's Virtual Machine records the addresses of some locations in the Compiled Program Description so that these locations can be accessed efficiently.

FIG. 14 is a high-level flow chart for part of the preferred embodiment's Virtual Machine.

FIG. 15 is a flow chart illustrating how the preferred embodiment's Virtual Machine executes the Process BASIC_ACTION_RECORD step shown as a single block in FIG. 14.

FIG. 16 is a flow chart illustrating how the preferred embodiment's Virtual Machine executes the Process LOOP_END_ACTION_RECORD step shown as a single block in FIG. 14.

FIG. 17 is a flow chart illustrating how the preferred embodiment's Virtual Machine checks for the occurrence of an event that would trigger an FSM transition.

### DESCRIPTION OF THE PREFFERRED EMBODIMENT

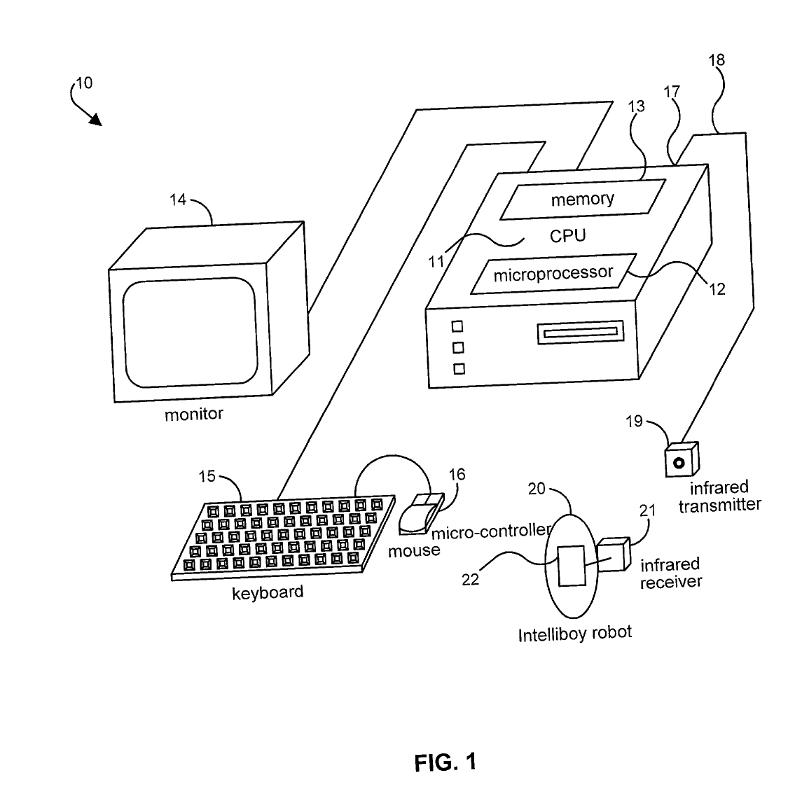

In FIG. 1, an exemplary preferred embodiment of the invention is illustrated. A personal computer 10 includes at least on central processing unit (CPU) 11 including a microprocessor 12 coupled to memory (such as RAM and hard disk) 13. Computer input and output may be displayed on a monitor 14 or other output device. User input is provided via a keyboard 15, a mouse 16, and other standard input devices. Attached to an RS-232 port 17 of personal computer 10 is an RS-232 cable 18. The other end of cable 18 is connected to an RS-232 port of an infrared transmitter 19. A modified Intelliboy robot 20 includes an infrared receiver 21 to receive information from infrared transmitter 19, and an ATMEL AT89S8252 Micro-controller 22 to control the robot toy. Personal computer 10 runs a user interface program (UI) which enables the user to create a Finite State Machine (FSM) that describes the desired behavior of the toy. Personal computer 10 also runs a Compiler which converts the FSM into a Compiled Program Description. Micro-controller 22 runs a Virtual Machine which executes the Compiled Program Description in a manner that causes the toy to exhibit the desired behavior. Personal computer 10 is conventional, and may be a microprocessor system, a personal digital assistant or other handheld computer, a workstation, a server, a network providing access to computation and input/output devices, or any of a variety of other apparatus providing computing and input/output capabilities.

All of the method steps described below are carried out using the apparatus shown in FIG. 1 together with the UI, the Compiler and the Virtual Machine. Thus the apparatus of FIG. 1 together with the UI, the Compiler and the Virtual Machine carry out all of the steps of the invention. Given the following detailed description of the method of the invention, it will be a routine matter for an engineer skilled in the art to produce code and assemble hardware to carry out all of the described steps.

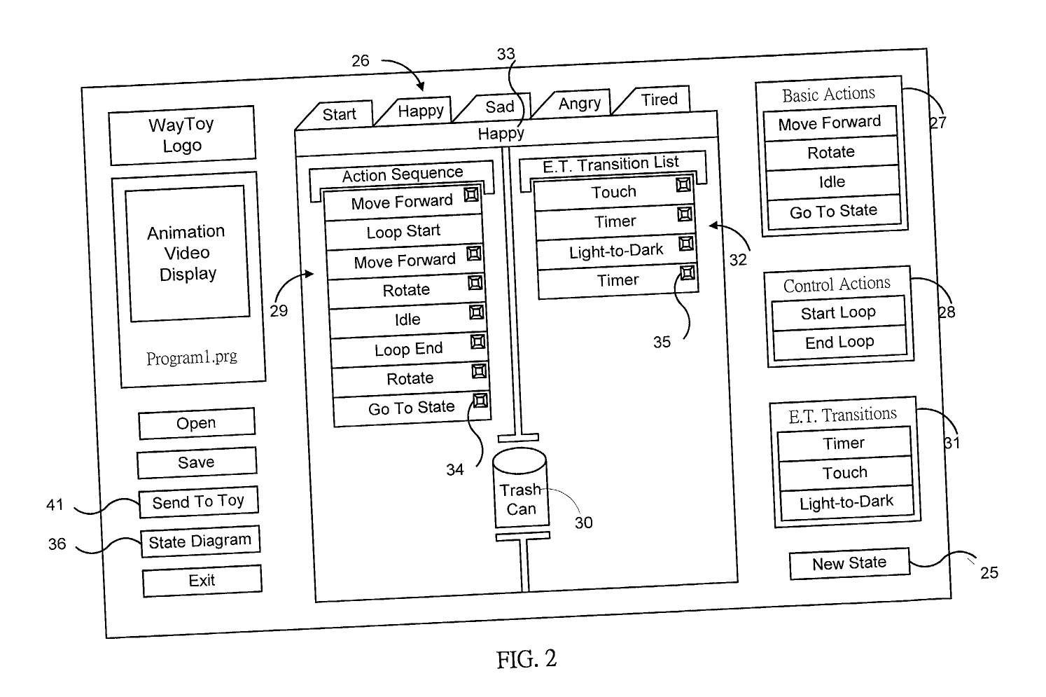

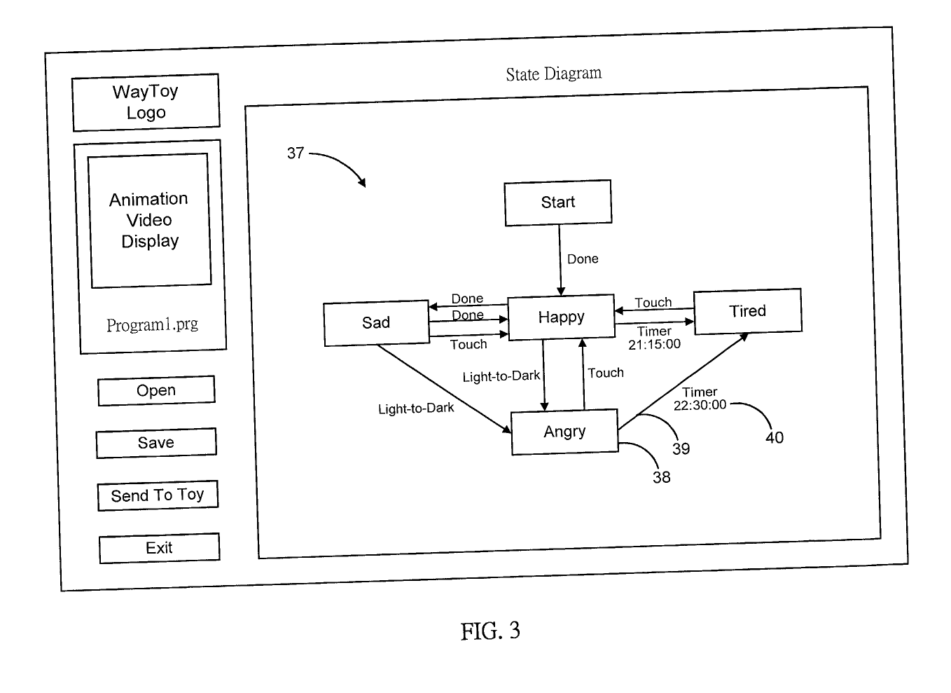

As noted above, the preferred embodiment enables the user to create an FSM that describes the desired behavior of the toy by using a user interface program (UI) running on personal computer 10. The UI is illustrated in FIG. 2 and FIG. 3. To create an FSM, the user needs to specify the FSM's states (States), the FSM's transitions (Transitions) and the sequences of actions that he wishes the toy to perform in each State (Action Sequences).

Specifying States Using the UI

When the UI is first invoked, it automatically creates the FSM's start State (i.e. the State which the toy will enter each time it begins running the program that the user is creating). For each additional State that the user wants to create, he clicks New State Button 25. This causes the UI to bring up a dialog box which allows the user to type in the name of the new State, and also allows the user to assign an icon to the new State to make it easier to remember what the State is for.

For each State, the UI enables the user to specify an Action Sequence 29 and an Event-Triggered Transition List 32 of Transitions to other States. To keep the process simple and easy to understand, the UI allows the user to work on only one State at a time. This State shall be referred to as the Currently-Editable State 33. After a new State is created, it automatically becomes the Currently-Editable State. To choose a different State to be the Currently-Editable State, the user clicks the name of that State in Tabbed List of States 26.

Specifying Action Sequences Using the UI

Each new State is created with an empty Action Sequence 29. To add an Action to the Action Sequence for the Currently-Editable State, the UI enables the user to select one of the Action boxes on Basic Action Menu 27 or Control Action Menu 28 and drag it to the Action Sequence. This causes the UI to create an instance of the corresponding Action (an Action Instance) in the Action Sequence at the location in the Action Sequence where the user stops dragging the Action box and drops (i.e. releases) it. The location of the Action Instance in the Action Sequence corresponds to the order in which the Action will be performed—the Virtual Machine will begin at the top of the Action Sequence and execute the Action Instances in descending order. The UI enables the user to change the execution order of any Action Instance in an Action Sequence by dragging it to a new location. The UI also enables the user to delete any Action Instance in an Action Sequence by dragging it to Trash Can 30.

While the invention does not place any limit on the number or variety of Actions that can be programmed, the preferred embodiment supports only four types of Basic Actions (accessible on Basic Action Menu 27) and one type of Control Action (accessible on Control Action Menu 28) because of the limitations of the toy's hardware. Each Action Instance on Action Sequence 29 has a property widget (e.g. Property Widget 34). The UI enables the user to click on any Action Instance's property widget to bring up a dialog box that offers various settings depending on the type of the Action Instance.

Three of the Basic Actions that can be instantiated from Basic Action Menu 27 are characterized by the motion of the toy while it is performing the Action: “Move Forward”, “Rotate” or “Idle”. For a Move Forward Action Instance, the property dialog box enables the user to specify the magnitude of the distance that the toy will move forward, the units of the distance that the toy will move forward (i.e. centimeters or inches) whether the toy will blink while it is moving, and whether the toy will play any of five different songs while it is moving. For a Rotate Action Instance, the property dialog box enables the user to specify how many degrees the toy will turn, whether the toy will blink while it is turning, and whether the toy will play any of five different songs while it is turning. For an Idle Action Instance, the property dialog box enables the user to specify how many seconds the toy will idle (i.e. remain motionless), whether the toy will blink while it is idling, and whether the toy will play any of five different songs while it is idling.

The fourth Basic Action that can be instantiated from Basic Action Menu 27 is a “Go To State” Action. The UI only allows one “Go To State” Action Instance on each Action Sequence 29, and it must appear at the end of the sequence. For a “Go To State” Action Instance, the property dialog box allows the user to specify which State the FSM will enter if it finishes executing the Action Sequence without taking an Event-Triggered Transition (see below). The UI does not require the user to specify a “Go To State” Action Instance for every Action Sequence. If an Action Sequence which has no “Go To State” Action Instance finishes, the Virtual Machine will stop the toy and wait for an Event-Triggered Transition to occur.

The Control Action that can be instantiated from Control Action Menu 28 is a “Loop” Action. Unlike all other Action Instances, each “Loop” Action Instance consists of two separately moveable pieces: one to mark the beginning of the loop and one to mark the end of the loop in an Action Sequence. For a “Loop” Action Instance, the property dialog box allows the user to specify the number of times that the Action Instances inside the Loop will be executed. The UI allows nesting of loops up to a maximum of depth of eight.

Specifying Transitions Using the UI

Each new State is created with an empty Event-Triggered Transition List 32. To add an Event-Triggered Transition to the Event-Triggered Transition List for the Currently-Editable State, the UI enables the user to select one of the Event-Triggered Transition boxes on Event-Triggered Transition Menu 31 and drag it to the Event-Triggered Transition List. This causes the UI to create an instance of the corresponding Event-Triggered Transition (an Event-Triggered Transition Instance) in the Event-Triggered Transition List. The Event-Triggered Transition Instance will be enabled whenever the FSM is in the Currently-Editable State, and disabled whenever the FSM is not in the Currently-Editable State. The UI also enables the user to delete any Event-Triggered Transition Instance in an Event-Triggered Transition List by dragging it to Trash Can 30.

While the invention does not place any limit on the number or variety of Transitions that can be programmed, the preferred embodiment supports only three types of Event-Triggered Transitions (accessible on Event-Triggered Transition Menu 31). Each Event-Triggered Transition Instance on Event-Triggered Transition List 32 has a property widget (e.g. Property Widget 35). The UI enables the user to click on any Each Event-Triggered Transition Instance's property widget to bring up a dialog box that offers various settings depending on the type of the Event-Triggered Transition Instance.

The Transitions that can be instantiated from Event-Triggered Transition Menu 31 are characterized by the event that could trigger (i.e. cause) the FSM to execute the Transition: “Timer”, “Touch”, or “Light-to-Dark”. For a Timer Event-Triggered Transition Instance, the property dialog box enables the user to specify at what time (on a 24-hour clock) the FSM will execute the Transition if the Event-Triggered Transition Instance is enabled, and which State the FSM will enter when the Transition is executed. For a Touch Event-Triggered Transition Instance, the property dialog box enables the user to specify which State the FSM will enter if the Event-Triggered Transition Instance is enabled and the toy is touched on the head so as to activate its touch sensor, thereby causing the Transition to be executed. For a Light-to-Dark Event-Triggered Transition Instance, the property dialog box enables the user to specify which State the FSM will enter if the Event-Triggered Transition Instance is enabled and the toy leaves an area with a highly reflective surface and enters an area with a poorly reflective surface in such a way as to toggle its photoreceptor, thereby causing the Transition to be executed.

Viewing the Finite State Machine

The UI enables the user to see an overview of the FSM, in the form of a State Diagram 37. A State Diagram can be a useful aid to understanding the overall design of the FSM, and thus the relationships of the concepts underlying the toy program. An example of the State Diagram that the UI draws for the user is illustrated in FIG. 3. To view a State Diagram, the user clicks the State Diagram button 36.

State Diagram 37 shows a box 38 for each State, labeled with the State's name. The State Diagram also shows an arrow 39 for each Event-Triggered Transition and Go To State Action illustrating the State that the FSM will leave (at the beginning of the arrow) and the State that the FSM will enter (at the end of the arrow). Each arrow has a label 40: for an Event-Triggered Transition arrow the label is the event that will trigger the Transition (if it is enabled), and for a Go To State Action arrow the label is the word “Done” (because the completion of an Action Sequence is what will trigger the State change indicated by the arrow).

The UI enables the user to easily change from the “view the State Diagram” mode illustrated in FIG. 3 to the “edit the FSM” mode illustrated in FIG. 2: double-clicking on any State box in State Diagram 37 will cause the UI to switch to the “edit the FSM” mode with the clicked-on State as the Currently-Editable State.

The preferred embodiment uses the “dot” program (from the Graphviz suite of tools version 1.7, copyright AT&T and Lucent Bell Labs) to compute an appropriate layout for State Diagram 37. To generate a State Diagram, the UI first scans its data structures to find all of the components of the FSM that need to be drawn, and prepares an input file for dot. After dot computes the layout, the UI uses a dot output file to display the drawing. The invention contemplates that any place-and-route program capable of producing such a diagram could be used instead of dot.

UI Data Structures for the Finite State Machine

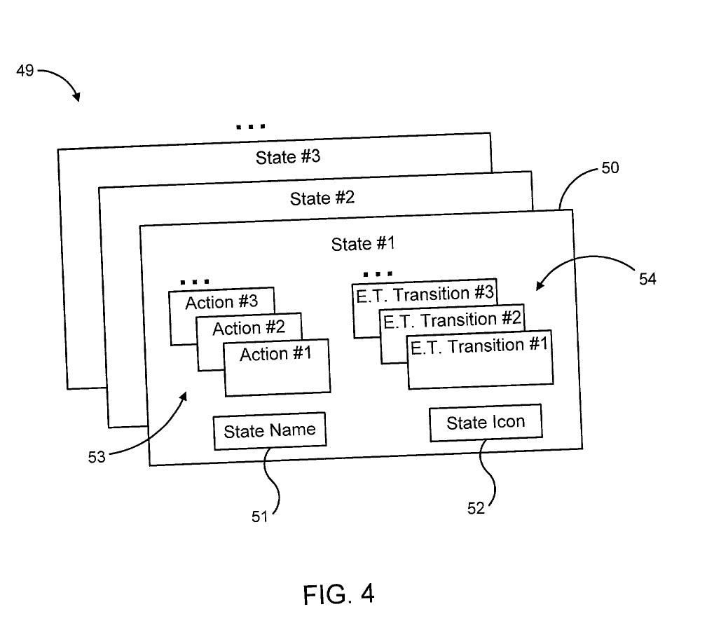

The preferred embodiment's UI stores the FSM in data structures in memory while it is running. The UI's State List 49 is illustrated in FIG. 4. Each State is represented by a State Object 50 on State List 49 that stores the State's Name 51, the State's Icon 52, an Action Object List 53 that represents the State's Action Sequence 29, and an Event-Triggered Transition Object List 54 that represents the State's Event-Triggered Transition List 32. The first State on State List 49 is the Start State, which the FSM will enter each time the toy program begins executing.

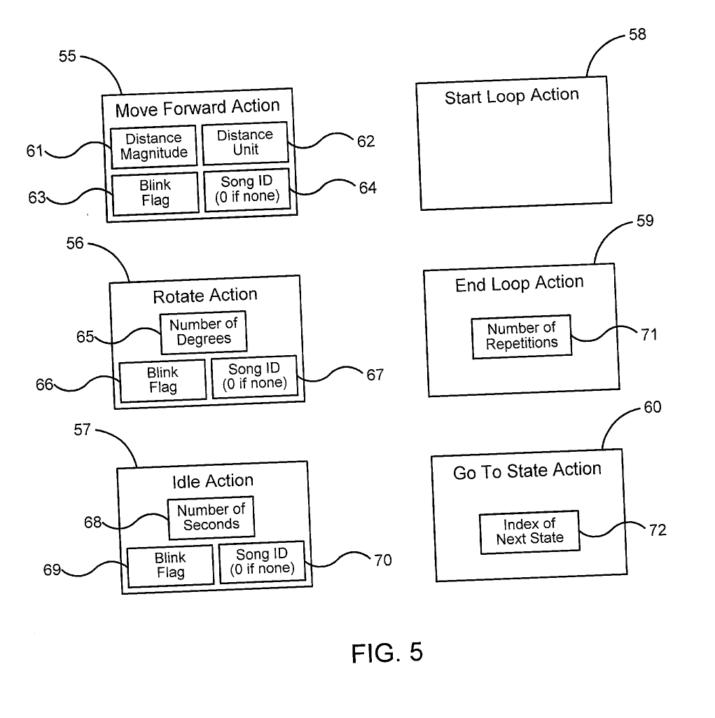

The UI's data structures for Action Objects are illustrated in FIG. 5. Each Move Forward Action Instance on Action Sequence 29 is represented by a Move Forward Action Object 55 that stores the Unit of Movement 62 (centimeters or inches), the Magnitude of Movement 61 (e.g. 7), a boolean Blink Flag 63 to indicate whether the toy should blink while it is moving, and a Song ID 64 which is the index of the song that the toy should play while moving (0 means don't play any song). Each Rotate Action Instance on Action Sequence 29 is represented by a Rotate Action Object 56 that stores the Number of Degrees 65 that the toy should turn clockwise, a boolean Blink Flag 66 to indicate whether the toy should blink while it is turning, and a Song ID 67 which is the index of the song that the toy should play while turning (0 means don't play any song). Each Idle Action Instance on Action Sequence 29 is represented by a Idle Action Object 57 that stores the Number of Seconds 68 the toy should idle, a boolean Blink Flag 69 to indicate whether the toy should blink while it is idling, and a Song ID 70 which is the index of the song that the toy should play while idling (0 means don't play any song). Each Loop Action Instance on Action Sequence 29 is represented by two objects: a Start Loop Action Object 58 that marks the location of the beginning of the loop, and an End Loop Action Object 59 that marks the location of the end of the Loop and stores the Number of Repetitions 71 which indicates the number of times the Actions within the Loop should be executed. Each Go To State Action Instance on Action Sequence 29 is represented by a Go To State Action Object 60 that stores the Index of Next State 72, which is the index of the State that the FSM should enter when the Action Sequence in which this Go To State Action Instance is stored is completed.

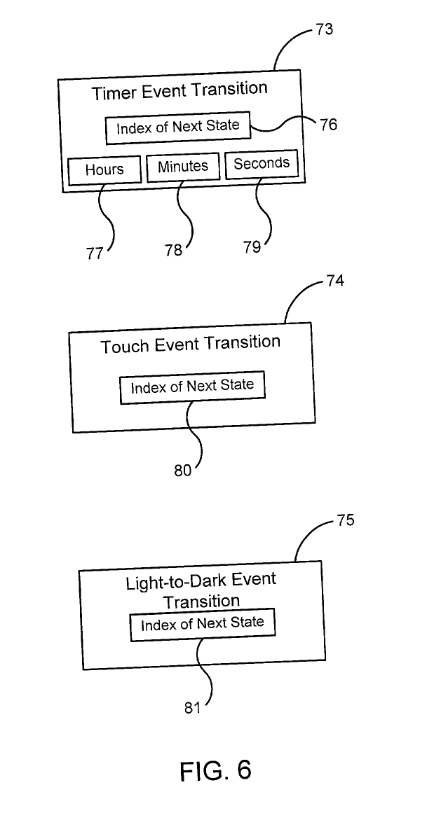

The UI's data structures for Event-Triggered Transition Instances are illustrated in FIG. 6. Each Timer Event-Triggered Transition Instance on Event-Triggered Transition List 32 is represented by a Timer Event Transition Object 73 that stores the time (24-hour-clock time in Hours 77, Minutes 78 and Seconds 79) at which the FSM will execute the Transition if it is enabled, and the Index of Next State 76 which is the index of the State that the FSM will enter if the Transition is executed. Each Touch Event-Triggered Transition Instance on Event-Triggered Transition List 32 is represented by a Touch Event Transition Object 74 that stores the Index of the State 80, which is the index of the State that the FSM will enter if the Touch Event-Triggered Transition Instance is enabled and the toy is touched on the head so as to activate its touch sensor, thereby causing the Transition to be executed. Each Light-to-Dark Event-Triggered Transition Instance on Event-Triggered Transition List 32 is represented by a Light-to-Dark Event Transition Object 75 that stores the Index of Next State 81, which is the index of the State that the FSM will enter if the Light-to-Dark Event-Triggered Transition Instance is enabled and the toy leaves an area with a highly reflective surface and enters an area with a poorly reflective surface in such a way as to trigger its photoreceptor, thereby causing the Transition to be executed.

Compiling the FSM into a Toy Program and Sending it to the Toy

The UI enables the user to both compile the FSM into a program that will run on the toy and to send that program to the toy simply by clicking Send to Toy Button 41. When the user clicks Send to Toy Button 41, the preferred embodiment performs the following steps automatically: first converting the UI data structures to a Compiler Input File, second compiling the Compiler Input File to a Compiled Program Description File, and third sending the Compiled Program Description to the toy where it is stored for execution by the Virtual Machine.

The preferred embodiment assigns a unique number, called a Command ID, to each type of behavior that the toy is capable of performing under the control of the program. These are referred to as follows.

| | |
|---|---|
| MOVE_FORWARD_COMMAND_ID | Move Forward |
| ROTATE_COMMAND_ID | Rotate |
| BLINK_COMMAND_ID | Blink |
| PLAY_SONG_1_COMMAND_ID | Play Song #1 |
| PLAY_SONG_2_COMMAND_ID | Play Song #2 |
| PLAY_SONG_3_COMMAND_ID | Play Song #3 |
| PLAY_SONG_4_COMMAND_ID | Play Song #4 |
| PLAY_SONG_5_COMMAND_ID | Play Song #5 |

The preferred embodiment also assigns a unique number, called a Trigger-Event ID, to each type of event that the toy's sensors are capable of detecting and the toy program is capable of using to trigger the execution of a Transition. These are referred to as follows.

| | |
|---|---|
| TOUCH_EVENT_ID | toy is touched in such a way as to |
| | activate its touch sensor |
| LIGHT_TO_DARK_EVENT_ID | toy leaves an area with a highly |
| | reflective surface and enters an |
| | area with a poorly reflective |
| | surface in such a way as to |
| | toggle its photoreceptor |

Converting the UI Data Structures to a Compiler Input File

In the first compilation step, the UI scans its data structures and creates a file called the Compiler Input File. The Compiler Input File stores the information needed to compile the toy program in records. The records are grouped into three types of sections: State Action Records, Timer Transition Records, and Non-Timer Transition Records.

State Action Records Sections in a Compiler Input File

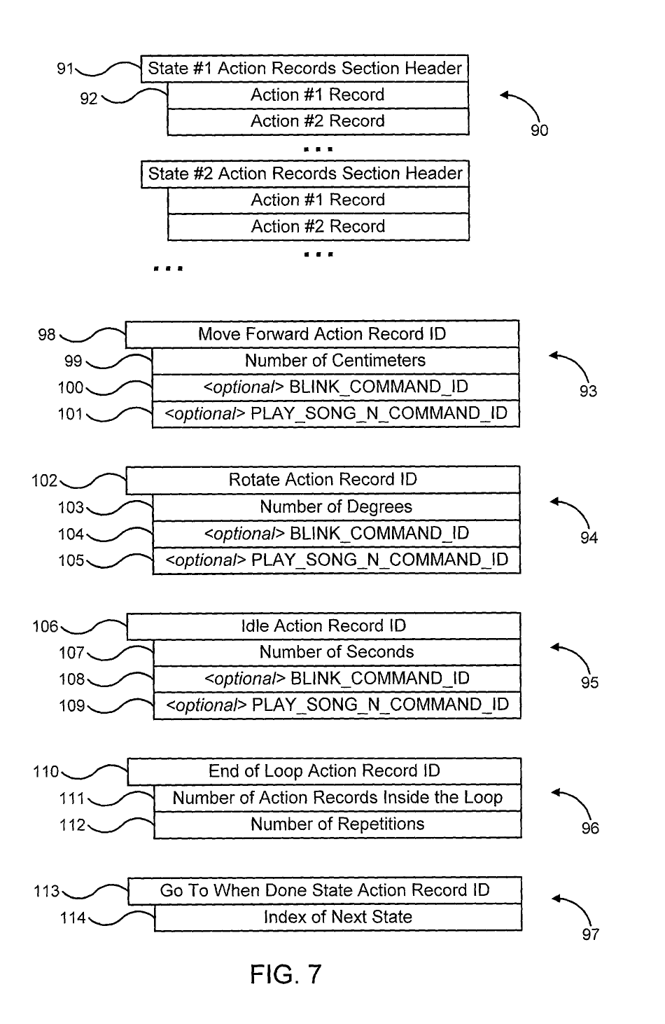

State Action Records sections in a Compiler Input File are illustrated in FIG. 7. The UI creates one State Action Records Section 90 for each State in the FSM. Each State has a unique State Index Number, which is not part of its data structure, but can be used to unambiguously refer to the State (e.g. in a Transition Record). The State Index Number of the Start State is always 1, and the other States are assigned consecutive State Index Numbers by the UI in the order in which the corresponding State Objects 50 are stored on State Object List 49. The State Action Records Sections are written into the Compiler Input File in order by State Index Number, so it is not necessary to write the State Index Numbers into the file. The UI starts each State Action Records Section by writing a State Action Records Section Header 91, which consists of a unique Section type number that distinguishes State Action Records Sections from other types of Sections. The UI then writes an Action Record 92 for each Action Object (except for a Start Loop Action Object 58) in the State's Action Object List 53, in order beginning with the first Action Object on List 53. Each Action Record 92 is actually one of the five specific types of Action Record which are illustrated in FIG. 7: Move Forward Action Record 93, Rotate Action Record 94, Idle Action Record 95, End of Loop Action Record 96, or Go To When Done State Action Record 97.

For a Move Forward Action Object 55, the UI writes a Move Forward Action Record 93. The UI begins the Record by writing Move Forward Action Record ID number 98, which is a unique Action Record type number that distinguishes Move Forward Action Records from other types of Action Records. The UI then writes Number of Centimeters 99 into the Move Forward Action Record. If the Distance Unit 62 in the Move Forward Action Object is centimeters, the UI writes the Distance Magnitude 61 from the Move Forward Action Object into the Move Forward Action Record. If the Distance Unit is inches, the UI multiplies the Distance Magnitude by 2.54 and writes the result into the Move Forward Action Record. Next the UI checks the Blink Flag 63 in the Move Forward Action Object. If the Blink Flag is true, the UI writes BLINK_COMMAND_ID 100 into the Move Forward Action Record. Next the UI checks the Song ID 64 in the Move Forward Action Object. If the Song ID is not 0, the UI writes the PLAY_SONG_N_COMMAND_ID 101 that corresponds to the Song ID, e.g. PLAY_SONG_1_COMMAND_ID if the Song ID is 1.

For a Rotate Action Object 56 the UI writes a Rotate Action Record 94. The UI begins the Record by writing Rotate Action Record ID number 102, which is a unique Action Record type number that distinguishes Rotate Action Records from other types of Action Records. The UI then writes Number of Degrees 65 from the Rotate Action Object into Number of Degrees 103 in the Rotate Action Record. Next the UI checks the Blink Flag 66 in the Rotate Action Object. If the Blink Flag is true, the UI writes BLINK_COMMAND_ID 104 into the Rotate Action Record. Next the UI checks the Song ID 67 in the Rotate Action Object. If the Song ID is not 0, the UI writes the PLAY_SONG_N_COMMAND_ID 105 that corresponds to the Song ID, e.g. PLAY_SONG_1_COMMAND_ID if the Song ID is 1.

For an Idle Action Object 57, the UI writes an Idle Action Record 95. The UI begins the Record by writing Idle Action Record ID number 106, which is a unique Action Record type number that distinguishes Idle Action Records from other types of Action Records. The UI then writes Number of Seconds 68 from the Idle Action Object into Number of Seconds 107 in the Idle Action Record. Next the UI checks the Blink Flag 69 in the Idle Action Object. If the Blink Flag is true, the UI writes BLINK_COMMAND_ID 108 into the Idle Action Record. Next the UI checks the Song ID 70 in the Idle Action Object. If the Song ID is not 0, the UI writes the PLAY_SONG_N_COMMAND_ID 109 that corresponds to the Song ID, e.g. PLAY_SONG_1_COMMAND_ID if the Song ID is 1.

For a Start Loop Action Object 58, the UI does not write an Action Record.

For an End Loop Action Object 59, the UI writes an End of Loop Action Record 96. The UI begins the Record by writing End of Loop Action Record ID number 110, which is a unique Action Record type number that distinguishes End of Loop Action Records from other types of Action Records. The UI then counts the number of Move Forward Action Objects, Rotate Action Objects, Idle Action Objects, and End Loop Action Objects that are between the End Loop Action Object and its corresponding Start Loop Action Object, and writes this count as Number of Action Records Inside the Loop 111 in the End Of Loop Action Record. The UI the writes Number of Repetitions 71 from the End Loop Action Object as Number of Repetitions 112 in the End of Loop Action Record.

For a Go To State Action Object 60, the UI writes a Go To When Done State Action Record 97. The UI begins the Record by writing Go To When Done State Action Record ID number 113, which is a unique Action Record type number that distinguishes Go To When Done State Action Records from other types of Action Records. The UI then writes Index of Next State 72 from the Go To State Action Object as Index of Next State 114 in the Go To When Done State Action Record.

Timer Transition Records Section in a Compiler Input File

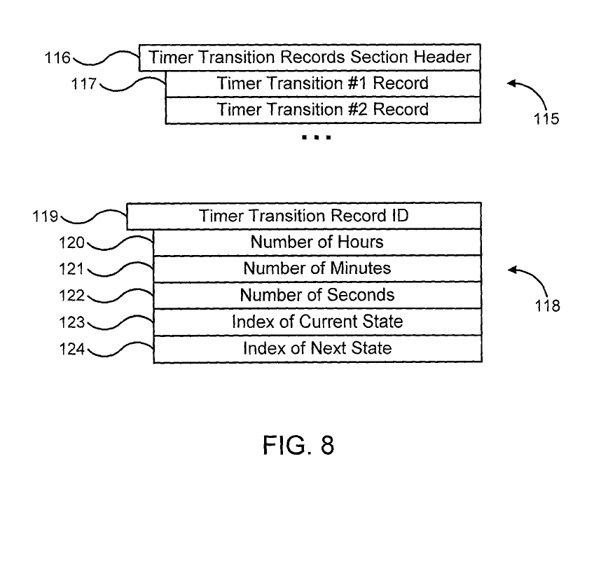

The Timer Transition Records Section 115 in a Compiler Input File is illustrated in FIG. 8. The UI starts the Timer Transition Records Section by writing a Timer Transition Records Section Header 116, which consists of a unique Section type number that distinguishes the Timer Transition Records Section from other types of Sections. The UI then writes one Timer Transition Record 117 for each Timer Event-Triggered Transition Object in the FSM.

To accomplish this, the UI scans State Object List 49. For each State Object 50 on List 49, the UI scans its Event-Triggered Transition Object List 54. For each Timer Event-Triggered Transition Object that the UI finds, the UI writes a Timer Transition Record 118 (which is the same thing as Timer Transition Record 117; 118 merely shows additional details) as follows. The UI begins by writing a Timer Transition Record ID 119, which is a unique type number that distinguishes the beginning of a Timer Transition Record from the beginning of a different section in the Compiler Input File. The UI then writes Hours 77 from the Timer Event-Triggered Transition Object as Number of Hours 120 in the Timer Transition Record. The UI then writes Minutes 78 from the Timer Event-Triggered Transition Object as Number of Minutes 121 in the Timer Transition Record. The UI then writes Seconds 79 from the Timer Event-Triggered Transition Object as Number of Seconds 122 in the Timer Transition Record. The UI then writes the State Index Number of the State Object currently being scanned as Index of Current State 123 in the Timer Transition Record. The UI then writes Index of Next State 76 from the Timer Event-Triggered Transition Object as Index of Next State 124 in the Timer Transition Record.

Non-Timer Transition Records Section in a Compiler Input File

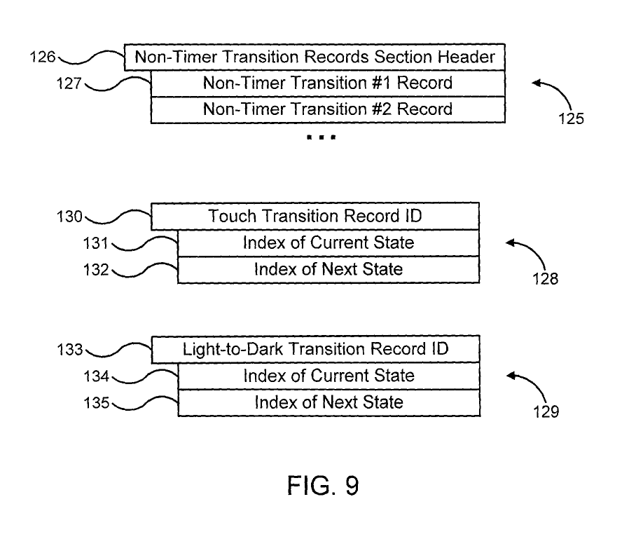

The Non-Timer Transition Records Section 125 in a Compiler Input File is illustrated in FIG. 9. The UI starts the Non-Timer Transition Records Section by writing a Non-Timer Transition Records Section Header 126, which consists of a unique Section type number that distinguishes the Non-Timer Transition Records Section from other types of Sections. The UI then writes one Non-Timer Transition Record 127 for each Touch Event-Triggered Transition Object 74 and each Light-to-Dark Event-Triggered Transition Object 75 in the FSM. Each Non-Timer Transition Record 127 is actually one of the two specific types of Non-Timer Transition Record which are illustrated in FIG. 9: Touch Transition Record 128 or Light-to-Dark Transition Record 129.

To accomplish this, the UI scans State Object List 49. For each State Object 50 on List 49, the UI scans its Event-Triggered Transition Object List 54. For each Touch Event-Triggered Transition Object 74 that the UI finds, the UI writes a Touch Transition Record 128 as follows. The UI begins by writing a Touch Transition Record ID 130, which is a unique type number that distinguishes the beginning of a Touch Transition Record from the beginning of a Light-to-Dark Transition Record or the beginning of a different section in the Compiler Input File. The UI then writes the State Index Number of the State Object currently being scanned as Index of Current State 131 in the Touch Transition Record. The UI ends the record by writing the Index of Next State 80 from the Touch Event-Triggered Transition Object as Index of Next State 132 in the Touch Transition Record. For each Light-to-Dark Event-Triggered Transition Object 75 that the UI finds, the UI writes a Light-to-Dark Transition Record 129 as follows. The UI begins by writing a Light-to-Dark Transition Record ID 133, which is a unique type number that distinguishes the beginning of a Light-to-Dark Transition Record from the beginning of a Touch Transition Record or the beginning of a different section in the Compiler Input File. The UI then writes the State Index Number of the State Object currently being scanned as Index of Current State 134 in the Light-to-Dark Transition Record. The UI ends the record by writing the Index of Next State 81 from the Light-to-Dark Event-Triggered Transition Object as Index of Next State 135 in the Light-to-Dark Transition Record.

Compiling the Compiler Input File to a Compiled Description File

In the second step, which is done after the UI completes the Compiler Input File, the UI calls a Compiler program that uses the contents of the Compiler Input File to create a corresponding Compiled Program Description File.

In the Compiled Program Description File, the preferred embodiment uses a set of unique identification numbers to indicate the beginning or end of particular types of information. This set of identification numbers and the set of Command ID numbers are disjoint. For clarity these identification numbers are referred to by the names listed below.

BEGIN_STATE_ACTION_SECTION

END_STATE_ACTION_SECTION

BASIC_ACTION_RECORD

DURATION_FIELD

LOOP_END_ACTION_RECORD

BEGIN_TIMER_TRANSITION_SECTION

END_TIMER_TRANSITION_SECTION

BEGIN_TIMER_TRANSITION_RECORD

END_TIMER_TRANSITION_RECORD

BEGIN_NONTIMER_TRANSITION_SECTION

END_NONTIMER_TRANSITION_SECTION

The Compiled Program Description File stores the information the Virtual Machine needs to execute the toy program in records. The records are grouped into three types of sections: State Action, Timer Transition, and Non-Timer Transition.

State Action Sections in a Compiled Program Description File

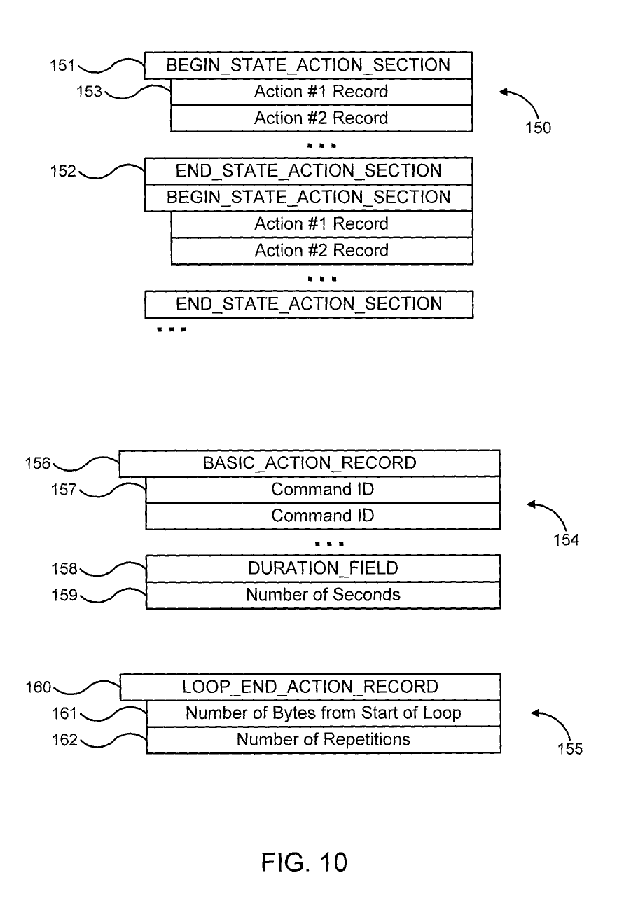

State Action sections in a Compiled Program Description File are illustrated in FIG. 10. The Compiler creates one State Action Section 150 in the Compiled Program Description File for each State Action Records Section 90 in the Compiler Input File, in the same order so that all State Index Numbers remain valid. The Compiler starts each State Action Section by writing BEGIN_STATE_ACTION_SECTION 151. The Compiler then writes an Action Record 153 for each Action Record 92 in the State Action Records Section 90 (except for Go To When Done State Action Records 97), in the same order so that the Action Sequence remains valid. Each Action Record 153 is actually one of the two specific types of Action Record which are illustrated in FIG. 10: Basic Action Record 154, or Loop End Action Record 155.After writing the last Action Record in the Section, the Compiler writes END_STATE_ACTION_SECTION 152.

For a Move Forward Action Record 93, the Compiler writes a Basic Action Record 154. The Compiler begins the Basic Action Record by writing BASIC_ACTION_RECORD 156. The Compiler then writes the Command ID's 157 needed to specify the desired behavior. The first Command ID the Compiler writes is MOVE_FORWARD_COMMAND_ID. Then, if the Move Forward Action Record 93 has a BLINK_COMMAND_ID 100, the Compiler writes a copy of that Command ID. Then, if the Move Forward Action Record 93 has a PLAY_SONG_N_COMMAND_ID 101, the Compiler writes a copy of that Command ID. Next the Compiler writes DURATION_FIELD 158. Then the Compiler writes the Number of Seconds 159 that it will take the toy to travel Number of Centimeters 99 (from Move Forward Action Record 93), which the Compiler computes by adding one to the Number of Centimeters.

For a Rotate Action Record 94, the Compiler writes a Basic Action Record 154. The Compiler begins the Basic Action Record by writing BASIC_ACTION_RECORD 156. The Compiler then writes the Command ID's 157 needed to specify the desired behavior. The first Command ID the Compiler writes is ROTATE_COMMAND_ID. Then, if the Rotate Action Record 94 has a BLINK_COMMAND_ID 104, the Compiler writes a copy of that Command ID. Then, if the Rotate Action Record 94 has a PLAY_SONG_N_COMMAND_ID 105, the Compiler writes a copy of that Command ID. Next the Compiler writes DURATION_FIELD 158. Then the Compiler writes the Number of Seconds 159 that it will take the toy to rotate Number of Degrees 103 (from Rotate Action Record 94), which the Compiler computes by multiplying the Number of Degrees by 0.083.

For an Idle Action Record 95, the Compiler writes a Basic Action Record 154. The Compiler begins the Basic Action Record by writing BASIC_ACTION_RECORD 156. The Compiler then writes any Command ID's 157 needed to specify the desired behavior. If the Idle Action Record 95 has a BLINK_COMMAND_ID 108, the Compiler writes a copy of that Command ID. Then, if the Idle Action Record 95 has a PLAY_SONG_N_COMMAND_ID 109, the Compiler writes a copy of that Command ID. Next the Compiler writes DURATION_FIELD 158. Then the Compiler writes the Number of Seconds 159, which is a copy of Number of Seconds 107 (from Idle Action Record 95).

For an End of Loop Action Record 96, the Compiler writes a Loop End Action Record 155. The Compiler begins the Loop End Action Record by writing LOOP_END_ACTION_RECORD 160. Then the Compiler scans all of the Records in State Action Section 150 that are inside the loop, adds up the number of bytes used to store them, and writes out the result as Number of Bytes from Start of Loop 161. The Compiler uses Number of Action Records Inside the Loop 111 (from End of Loop Action Record 96) to determine the number of prior Records it needs to scan to compute the correct result. Then the Compiler writes the Number of Repetitions 162, which is a copy of Number of Repetitions 112 (from End of Loop Action Record 96).

For a Go To When Done State Action Record 97, the Compiler does not write a record into the State Action Section 150. The information in the Go To When Done State Action Record 97 is used later to create a record in a different section of the Compiled Program Description File.

Timer Transition Section in a Compiled Program Description File

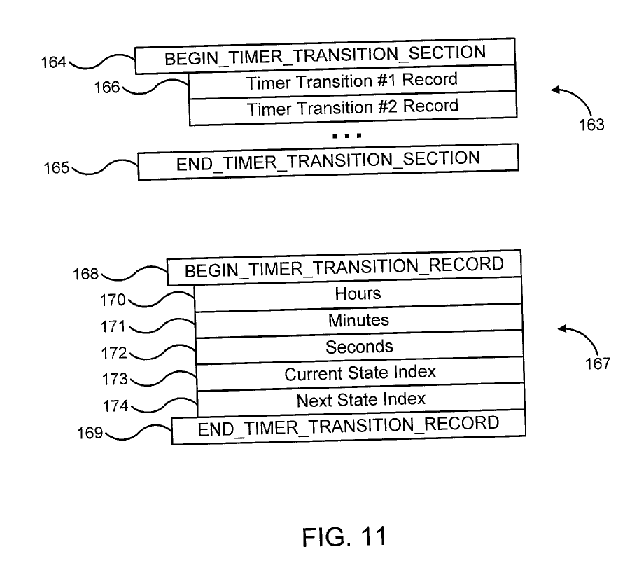

The Timer Transition Section 163 in a Compiled Program Description File is illustrated in FIG. 11. The Compiler starts the Timer Transition Section 163 by writing BEGIN_TIMER_TRANSITION_SECTION 164. Next the Compiler writes one Timer Transition Record 166 for each Timer Transition Record 118 in the Timer Transition Records Section 115 of the Compiler Input File. Then the Compiler ends the Timer Transition Section 163 by writing END_TIMER_TRANSITION_SECTION 165.

For each Timer Transition Record 118 in the Compiler Input File, the Compiler writes a Timer Transition Record 167 (which is the same thing as Timer Transition Record 166; 167 merely shows additional details) as follows. The Compiler begins the Timer Transition Record 167 by writing BEGIN_TIMER_TRANSITION_RECORD 168. The Compiler then writes Number of Hours 120 from the Timer Transition Record 118 as Hours 170 in the Timer Transition Record 167. The Compiler then writes Number of Minutes 121 from the Timer Transition Record 118 as Minutes 171 in the Timer Transition Record 167. The Compiler then writes Number of Seconds 122 from the Timer Transition Record 118 as Seconds 172 in the Timer Transition Record 167. The Compiler then writes Index of Current State 123 from the Timer Transition Record 118 as Current State Index 173 in the Timer Transition Record 167. The Compiler then writes Index of Next State 124 from the Timer Transition Record 118 as Next State Index 174 in the Timer Transition Record 167. After that, the Compiler finishes the Timer Transition Record 167 by writing END_TIMER_TRANSITION_RECORD 169.

Non-Timer Transition Section in a Compiled Program Description File

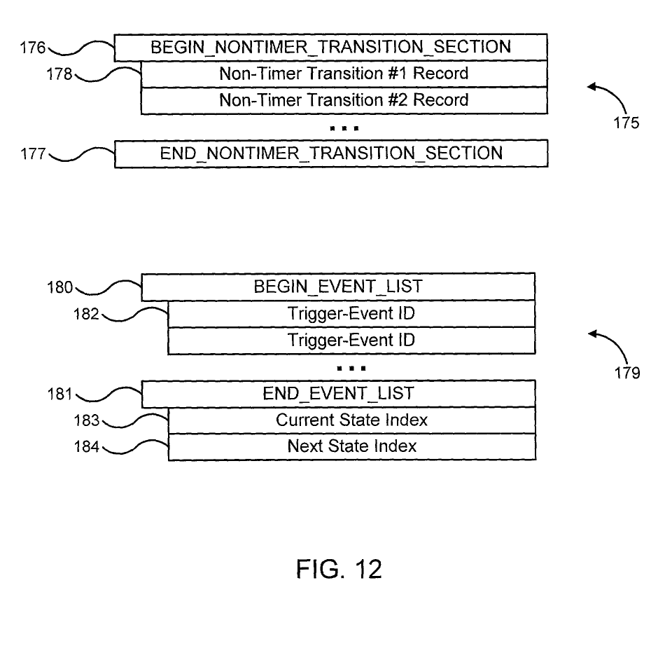

The Non-Timer Transition Section 175 in a Compiled Program Description File is illustrated in FIG. 12. The Compiler starts the Non-Timer Transition Section 175 by writing BEGIN_NONTIMER_TRANSITION_SECTION 176. Next the Compiler writes one Non-Timer Transition Record 178 (which is the same thing as Non-Timer Transition Record 179; 179 merely shows additional details) for each Non-Timer Transition Record 127 in the Non-Timer Transition Records Section 125 of the Compiler Input File. Then the Compiler ends the Non-Timer Transition Section 175 by writing END_NONTIMER_TRANSITION_SECTION 177.

For each Touch Transition Record 128 in the Compiler Input File, the Compiler writes a Non-Timer Transition Record 179 as follows. The Compiler begins the Non-Timer Transition Record 179 by writing BEGIN_EVENT_LIST 180. The Compiler then writes TOUCH_EVENT_ID as Trigger-Event ID 182. The Compiler then writes END_EVENT_LIST 181. The Compiler then writes Index of Current State 131 from the Touch Transition Record 128 as Current State Index 183 into the Non-Timer Transition Record 179. The Compiler then writes Index of Next State 132 from the Touch Transition Record 128 as Next State Index 184 in the Non-Timer Transition Record 179.

For each Light-to-Dark Transition Record 129 in the Compiler Input File, the Compiler writes a Non-Timer Transition Record 179 as follows. The Compiler begins the Non-Timer Transition Record 179 by writing BEGIN_EVENT_LIST 180. The Compiler then writes LIGHT_TO_DARK_EVENT_ID as Trigger-Event ID 182. The Compiler then writes END_EVENT_LIST 181. The Compiler then writes Index of Current State 134 from the Light-to-Dark Transition Record 129 as Current State Index 183 into the Non-Timer Transition Record 179. The Compiler then writes Index of Next State 135 from the Light-to-Dark Transition Record 129 as Next State Index 184 in the Non-Timer Transition Record 179.

For each State Action Records Section 90 in the Compiler Input File, the Compiler finds each Go To When Done State Action Record 97. For each such Record, the Compiler writes a Non-Timer Transition Record 179 as follows. The Compiler begins the Non-Timer Transition Record 179 by writing BEGIN_EVENT_LIST 180. The Compiler then writes END_EVENT_LIST 181. The Compiler then writes the State Index Number of the State Action Records Section 90 (implied by its order in the Compiler Input File) as Current State Index 183 into the Non-Timer Transition Record 179. The Compiler then writes Index of Next State 114 from the Go To When Done State Record 97as Next State Index 184 in the Non-Timer Transition Record 179.

Sending the Compiled Program Description to the Toy

The preferred embodiment sends the Compiled Program Description File bits (referred to below as the Compiled Program Description) through the RS-232 port 17 of personal computer and RS_232 cable 18 to infrared transmitter 19. From infrared transmitter 19 the Compiled Program Description bits are transmitted to infrared receiver 21 and are then sent to the ATMEL AT89S8252 Micro-controller 22 inside the toy for storage.

In the preferred embodiment, Micro-controller 22 is programmed to execute a Virtual Machine. The Virtual Machine has two main functions: to store the Compiled Program Description as it arrives from infrared receiver 21, and to use the Compiled Program Description to control the toy so that it exhibits the behavior specified by the user.

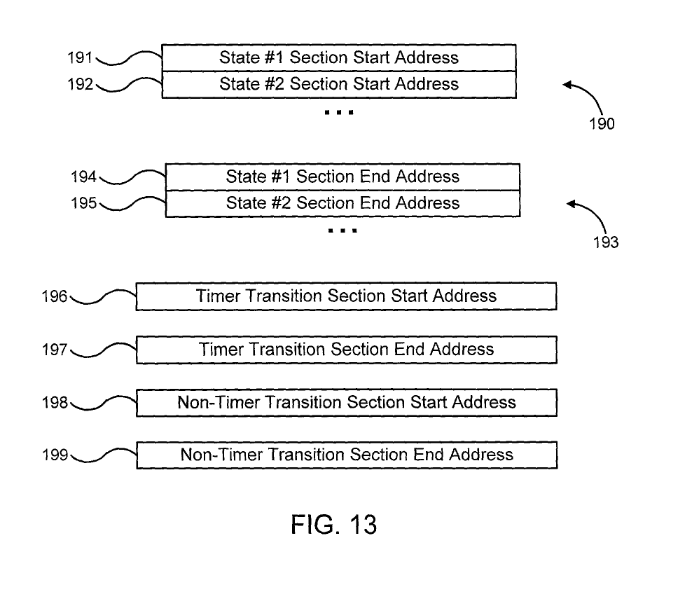

As the Compiled Program Description bits reach Micro-controller 22, the Virtual Machine writes the Compiled Program Description into contiguous memory in the Micro-controller. As it does so, the Virtual Machine records the address of the start of each Section and the address of the end of each Section as illustrated in FIG. 13. The Virtual Machine stores the address of the first Action Record in each State Section in State Section Start Array 190. The start address of the first Action Record in the first State Section is stored in State #1 Section Start Address 191, the start address of the first Action Record in the second State Section is stored in State #2 Section Start Address 192, etc. The Virtual Machine stores the end address of each State Section in State Section End Array 193. The end address of the first State Section is stored in State #1 Section End Address 194, the end address of the second State Section is stored in State #2 Section End Address 195, etc. The Virtual Machine stores the address of the first Timer Transition Record in Timer Transition Section 163 in Timer Transition Section Start Address 196. The Virtual Machine stores the end address of Timer Transition Section 163 in Timer Transition Section End Address 197. The Virtual Machine stores the address of the first Non-Timer Transition Record in Non-Timer Transition Section 175 in Non-Timer Transition Section Start Address 198. The Virtual Machine stores the end address of Non-Timer Transition Section 175 in Timer Transition Section End Address 199.

Execution of the Compiled Program Description by the Virtual Machine

The Virtual Machine uses several variables to execute the Compiled Program Description. These variables are described below.

| | | |
|---|---|---|
| Action_Duration | integer | the amount of time the Virtual |
| | | Machine needs to continue running |
| | | the current Action in order to |
| | | completely finish it |
| Action_Time | integer | the amount of time that has elapsed |
| | | since the Virtual Machine began |
| | | running the current Action |
| Change_State | boolean | true if the Virtual Machine needs |
| | | to change the State of the FSM |
| Count_Stack | integer | array number of repetitions remaining |
| | | for each loop that is currently being |
| | | executed (in order of nesting, with |
| | | the number of repetitions for the |
| | | outermost executing ioop stored at |
| | | the beginning ofthe array) |
| Current_State | integer | State Index Number of the current |
| | | State of the ESM |
| Light_To_Dark_Flag | boolean | true if a toy has just left an area with |
| | | a highly reflective surface and |
| | | entered an area with poorly reflective |
| | | surface in such a way as to toggle |
| | | its photoreceptor |
| Location_Stack | address | array holds the address of the Loop |
| | | End Action Record 155 for each loop |
| | | that is currently being executed |
| | | (in order of nesting, with the address |
| | | corresponding to the outermost |
| | | executing loop stored at the |
| | | beginning of the array) |
| New_State | integer | State Index Number of the next State |
| | | the FSM will enter, valid only if |
| | | Change State is true |
| Program_Pointer | address | address in the current State Action |
| | pointer | Section from which the Virtual |
| | | Machine will read the next Action |
| | | information (unless the Action |
| | | Sequence is done) |
| Program_End_Pointer | address | address at which the Virtual Machine |
| | pointer | will stop reading Action information |
| | | from the current State Action Section, |
| | | because at that point the Action |
| | | Sequence for the ESMs current State |
| | | has been completed |
| Stack_Index | integer | the index of the first empty location |
| | | on the loop-control stacks |
| Touch_Flag | boolean | true if the toy has just been touched |
| | | in such a way as to activate its |
| | | touch sensor |
| Wall_Clock | integer | array the current time represented as |
| | | hours (Wall_Clock[0]), |
| | | minutes (Wall_Clock[l]) and |
| | | seconds (Wall_Clock[2]) on a |
| | | 24-hour clock |

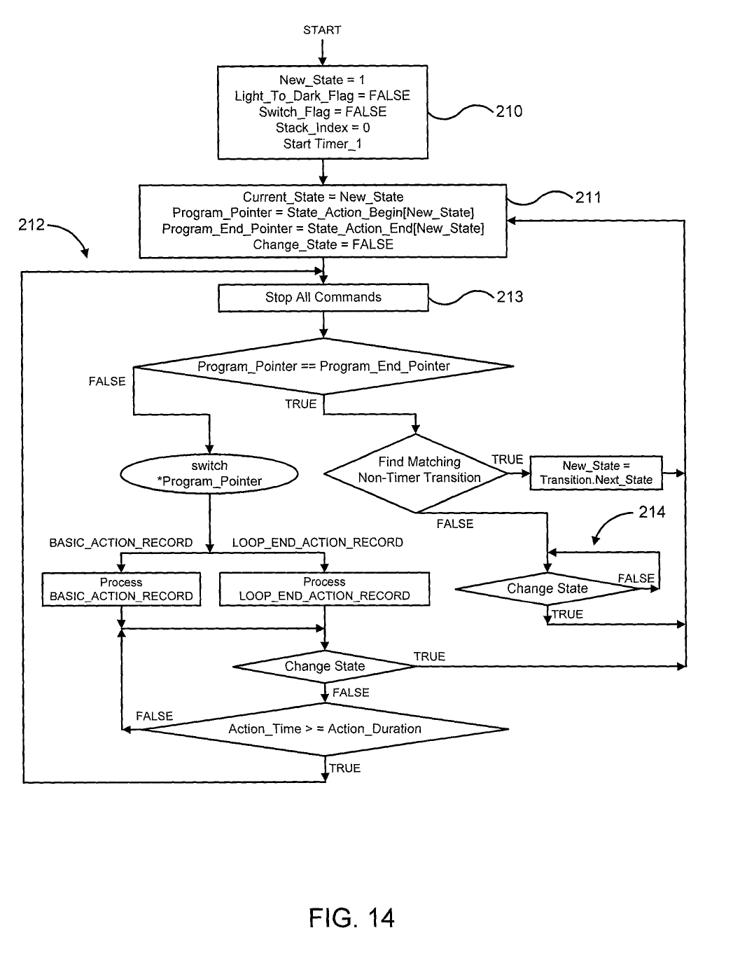

A high-level flow chart for part of the Virtual Machine is shown in FIG. 14. When the toy program starts, the Virtual Machine executes Program Initialization 210. The Virtual Machine sets New_State to 1 so that the FSM will enter State #1 (the Start State) in State Initialization 211. The Virtual Machine also sets Light_To_Dark_Flag and Touch_Flag to FALSE, and Stack_Index to 0. In addition, the Virtual Machine starts Timer_1 on Micro-controller 22. Then the Virtual Machine proceeds to State Initialization 211.

In State Initialization 211, the Virtual Machine sets Current_State to New_State, and sets Change_State to FALSE. The Virtual Machine also sets Program_Pointer to the address of the first Action Record in the State, by using Current_State as the index to look up the address in State Section Start Array 190. In addition, the Virtual Machine also sets Program_End_Pointer to the address of the end of the State Action Section for the State, by using Current_State as the index to look up the address in State Section End Array 193. Then the Virtual Machine proceeds to executing Action Sequence Loop 212 for the State.

Each complete pass through Action Sequence Loop 212 performs one Action Record 153. For each Action Record, the Virtual Machine first executes Stop All Commands 213 to stop any commands that are running because of the previous Action Record. This is necessary because once a command is started by the Virtual Machine, it continues to run until the Virtual Machine stops it. For example, if an Action Record causes the Virtual Machine to signal the toy's motor to move the toy forward, that signal will be continued until Stop All Commands 213 stops the signal. Stop All Commands 213 stops not only forward motion, but also rotation, blinking, and song playing.

After Stop All Commands 213, the Virtual Machine checks whether Program_Pointer is equal to Program_End_Pointer.

If Program_Pointer is equal to Program_End_Pointer, the Action Sequence for the current State is completed. The Virtual Machine searches through the NonTimer Transition Section 175 to find any NonTimer Transition Record 179 that has no Trigger-Event ID 182 and has a Current State Index 183 equal to Current_State. If such a Record is found, the Virtual Machine sets New_State to the Record's Next State Index 184, and goes to the next State of the FSM by executing State Initialization 211 again. If no such Record is found, the Virtual Machine goes into Wait for Change_State Loop 214. Wait for Change_State Loop 214 continues until Change_State becomes TRUE, at which time the Virtual Machine will go to the next State of the FSM by executing State Initialization 211 again.

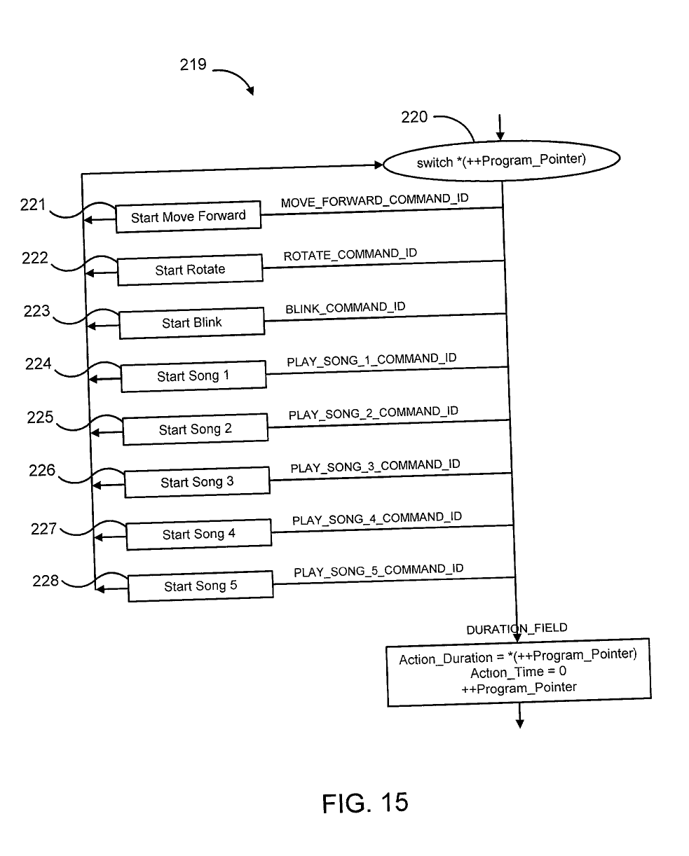

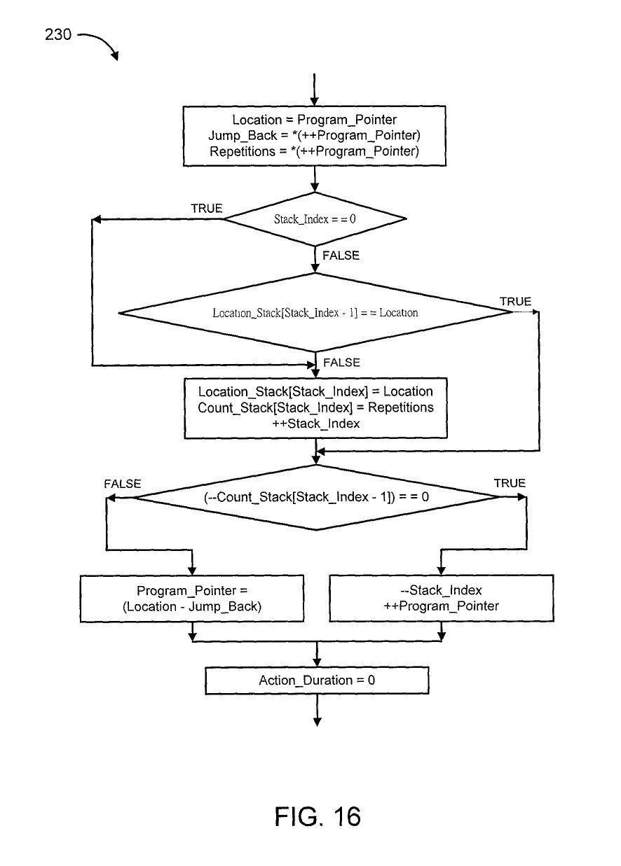

If Program_Pointer is not equal to Program_End_Pointer, the Virtual Machine checks the address that Program_Pointer is pointing to. If Program_Pointer is pointing to BASIC_ACTION_RECORD, the Virtual Machine executes Process BASIC_ACTION_RECORD, which is illustrated in FIG. 15 and described below. If Program_Pointer is pointing to LOOP_END_ACTION_RECORD, the Virtual Machine executes Process LOOP_END_ACTION_RECORD, which is illustrated in FIG. 16 and described below.

After executing either Process BASIC_ACTION_RECORD or Process LOOP_END_ACTION_RECORD, the Virtual Machine checks Change_State. If Change_State is TRUE, the Virtual Machine goes to the next State of the FSM by executing State Initialization 211 again. Otherwise the FSM compares Action_Time to Action_Duration. If Action_Time is greater than or equal to Action_Duration, then the current Action has run long enough, and the Virtual Machine prepares to perform the next Action in the Action Sequence (if any) by going back to Stop All Commands 213. If Action_Time is less than Action_Duration, then the Virtual Machine continues running the current Action by looping back to check Change_State and then Action_Time again.

As mentioned above, Process BASIC_ACTION_RECORD 219 is illustrated in FIG. 15. The Virtual Machine first executes Step 220, in which it increments Program_Pointer and then checks the address that it is pointing to, which will be either Command ID 157 or DURATION_FIELD 158. If Program_Pointer is pointing to MOVE_FORWARD_COMMAND_ID, the Virtual Machine executes Start Move Forward 221, and then goes back to Step 220. In Start Move Forward 220, the Virtual Machine begins driving a logic high value on the pin of Micro-controller 22 that is connected to the control pin of the toy's forward motion motor, causing the motor to begin to run and move the toy forward. If Program_Pointer is pointing to ROTATE_COMMAND_ID, the Virtual Machine executes Start Rotate 222, and then goes back to Step 220. In Start Rotate 220, the Virtual Machine begins driving a logic high value on the pin of Micro-controller 22 that is connected to the control pin of the toy's rotation motor, causing the motor to begin to run and turn the toy clockwise. If Program_Pointer is pointing to BLINK_COMMAND_ID, the Virtual Machine executes Start Blink 223, and then goes back to Step 220. In Start Blink 223, the Virtual Machine begins running a short routine which alternates driving a logic high value and a logic low value two times per second on the pin of Micro-controller 22 that is connected to the control pin of the toy's blink actuator, causing the toy's eyelids to alternately rise and fall. If Program_Pointer is pointing to PLAY_SONG_1_COMMAND_ID, the Virtual Machine executes Start Song 1 224, and then goes back to Step 220. In Start Song 1 224, the Virtual Machine begins running a short routine which drives a sequence of logic values on the pin of Micro-controller 22 that is connected to the control pin of the toy's speaker so as to cause the speaker to play the notes of Song #1, which has been programmed into the toy's memory. If Program_Pointer is pointing to PLAY_SONG_2_COMMAND_ID, the Virtual Machine executes Start Song 2 225, and then goes back to Step 220. In Start Song 2 225, the Virtual Machine begins running a short routine which drives a sequence of logic values on the pin of Micro-controller 22 that is connected to the control pin of the toy's speaker so as to cause the speaker to play the notes of Song #2, which has been programmed into the toy's memory. If Program_Pointer is pointing to PLAY_SONG_3_COMMAND_ID, the Virtual Machine executes Start Song 3 226, and then goes back to Step 220. In Start Song 3 226, the Virtual Machine begins running a short routine which drives a sequence of logic values on the pin of Micro-controller 22 that is connected to the control pin of the toy's speaker so as to cause the speaker to play the notes of Song #3, which has been programmed into the toy's memory. If Program_Pointer is pointing to PLAY_SONG_4_COMMAND_ID, the Virtual Machine executes Start Song 4 227, and then goes back to Step 220. In Start Song 4 227, the Virtual Machine begins running a short routine which drives a sequence of logic values on the pin of Micro-controller 22 that is connected to the control pin of the toy's speaker so as to cause the speaker to play the notes of Song #4, which has been programmed into the toy's memory. If Program_Pointer is pointing to PLAY_SONG_5_COMMAND_ID, the Virtual Machine executes Start Song 5 228, and then goes back to Step 220. In Start Song 5 228, the Virtual Machine begins running a short routine which drives a sequence of logic values on the pin of Micro-controller 22 that is connected to the control pin of the toy's speaker so as to cause the speaker to play the notes of Song #5, which has been programmed into the toy's memory. If Program_Pointer is pointing to DURATION_FIELD, the Virtual Machine increments the Program_Pointer, reads Number of Seconds 159 from the current Basic Action Record 154 and stores the value in Action_Duration, sets the value of Action_Time to 0, and then increments the Program_Pointer again.

As mentioned above, Process LOOP_END_ACTION_RECORD 230 is illustrated in FIG. 16. Procedure 230 uses three local variables.

| | | |
|---|---|---|
| Location | address | address of the Loop End Action Record 155 being |
| | | processed |
| Jump_Back | integer | copy of Number Of Bytes from Start of Loop 161 |
| | | from the Loop End Action Record being |
| | | processed |
| Repetitions | integer | copy of Number of Repetitions 162 from the |
| | | Loop End Action Record being processed |

The Virtual Machine begins procedure 230 begins by setting Location to the value of the Program_Pointer. The Virtual Machine then increments Program_Pointer and sets Jump_Back to the value Program_Pointer is pointing to. The Virtual Machine then increments Program_Pointer again and sets Repetitions to the value Program_Pointer is pointing to. Next, if the Stack_Index is 0 or the value stored in the Location_Stack at position [Stack_Index-1] is the not the same as the value of Location, the value of Location is stored in Location_Stack at position [Stack_Index], the value of Repetitions is stored in Count_Stack at position [Stack_Index] and then Stack_Index is incremented. Next, the Virtual Machine decrements the value stored at position [Stack_Index-1] in Count_Stack. Then, if the value stored at position [Stack_Index-1] in Count_Stack is 0, the Virtual Machine decrements Stack_Index and increments Program_Pointer; otherwise the Virtual Machine sets Program_Pointer to (Location—Jump_Back). Next, to complete procedure 230, the Virtual Machine sets Action_Duration to 0.

In the preferred embodiment, the Interrupt 0 pin of Micro-controller 22 is connected to the output pin of the toy's photoreceptor. If Micro-controller 22 receives a signal on its Interrupt 0 pin, the Virtual Machine sets Light_To_Dark Flag to TRUE.

In the preferred embodiment, the Interrupt 1 pin of Micro-controller 22 is connected to the output pin of the toy's touch sensor. If Micro-controller 22 receives a signal on its Interrupt 1 pin, the Virtual Machine sets Touch_Flag to TRUE.

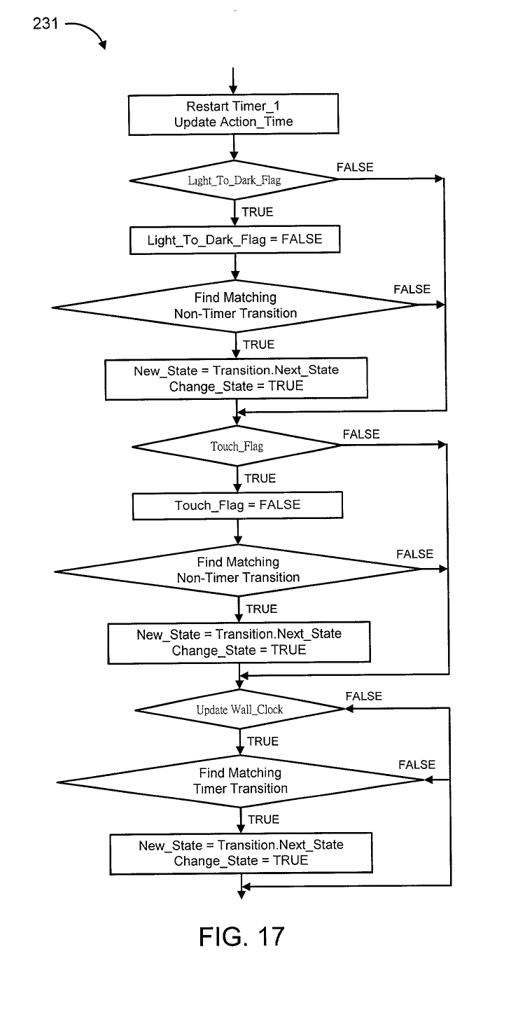

The Virtual Machine uses Timer_1 on Micro-controller 22 in Procedure 231 to interrupt the procedure illustrated in FIG. 14, FIG. 15 and FIG. 16 approximately once every 50 milliseconds to determine whether an event that might trigger a Transition has occurred, as illustrated in FIG. 17. Procedure 231 runs whenever Timer_1 reaches 0. The Virtual Machine first resets Timer_1 to run for 50 more milliseconds. Then the Virtual Machine increases Action_Time by the equivalent of 50 milliseconds. Next the Virtual Machine checks Light_To_Dark_Flag. If it is TRUE, the Virtual Machine resets Light_To_Dark_Flag to FALSE, and then searches through the NonTimer Transition Section 175 to find any NonTimer Transition Record 179 that has a Trigger-Event ID 182 equal to LIGHT_TO_DARK_EVENT_ID and a Current State Index 183 equal to Current_State. If such a Record is found, the Virtual Machine sets New_State to the Record's Next State Index 184, and sets Change_State to TRUE. Next the Virtual Machine checks Touch_Flag. If it is TRUE, the Virtual Machine resets Touch_Flag to FALSE, and then searches through the NonTimer Transition Section 175 to find any NonTimer Transition Record 179 that has a Trigger-Event ID 182 equal to TOUCH_EVENT_ID and a Current State Index 183 equal to Current_State. If such a Record is found, the Virtual Machine sets New_State to the Record's Next State Index 184, and sets Change_State to TRUE. Next the Virtual Machine determines whether Procedure 231 has been called 20 times since the last time Wall_Clock was updated. If so, the Virtual Machine advances Wall_Clock by one second, and then searches through the Timer Transition Section 163 to find any Timer Transition Record 167 that has Hours 170 equal to Wall_Clock[0], Minutes 171 equal to Wall_Clock[1], Seconds 172 equal to Wall_Clock[2], and Current_State_Index 173 equal to Current_State. If such a Record is found, the Virtual Machine sets New_State to the Record's Next State Index 174, and sets Change_State to TRUE.

Correspondance of the Preferred Embodiment to the Claims

1) In the preferred embodiment, the “input means” referred to in the claims is the user interface program (UI) running on personal computer 10, as described above.

2) In the preferred embodiment, the “device” referred to in the claims is the modified Intelliboy robot 20 including the infrared receiver 21, the ATMEL AT89S8252 Micro-controller 22, and the Virtual Machine as described above.

3) In the preferred embodiment, the means referred to in the claims of converting a finite state machine description to a program which the device can execute is the part of the UI that creates the Compiler Input File as well as the Compiler itself, as described above.

4) In the preferred embodiment, the means referred to in the claims of sending the program to the device is RS-232 port 17 of personal computer 10 which is connected via RS-232 cable 18 to an RS-232 port of infrared transmitter 19, which sends the program using infrared signals to infrared receiver 21 which is connected to Intelliboy robot 20, as described above.

5) In the preferred embodiment, the means referred to in the claims of storing the program in the device is the part of the Virtual Machine which accepts the program from infrared receiver 21 and stores it in the memory of ATMEL AT89S8252 Micro-controller 22.

Conclusion, Ramifications, and Scope of Invention

Thus the reader will see that the invention enables people who are not familiar with software engineering or hardware control technology to easily program a device to behave as desired. While the above description contains many specifics, these should not be construed as limitations on the scope of the invention, but rather as an exemplification of one preferred embodiment thereof. Many other variations are possible.

For example, the controlled device may be a furnace, an air conditioner, a washing machine, a house lighting controller, a landscape sprinkler system, a television-program recorder, a music player, a cleaning robot, a doll, a toy robot, a toy train, a toy airplane, a toy car or other toy vehicle, or any other machine that people want to program to operate autonomously or semi-autonomously.

For example, a controlled-device action can be moving, speaking, singing, playing music or sound effects, heating, cooling, spraying water, recording a television program, or anything else that the controlled device is capable of doing under program control.

For example, an action sequence can include controlled-device actions, loops, “if then else” statements, boolean operators, relational operators, arithmetic operators, expressions, macros, functions, random number generators, arrays, stacks, or any other programming construct.

For example, controlled-device actions can be programmed to occur while the FSM is in a state, while the FSM is executing a transition, or both.

For example, FSM transitions can be triggered by touch, temperature, pressure, humidity, time, emptiness or fullness of a container, scent, smoke, chemicals, visible light, infrared light, radio waves, sounds, speech, or any other events, conditions, or physical entities that the device can detect. FSM transitions can also be triggered by any function of one or more such events, conditions or physical entities.

For example, the priority of the FSM transitions from each state (i.e. which transition will be executed if more than one transition is triggered while the FSM is in that state) can be predetermined by the implementation based on the type of trigger, can be set by the user, can be random or pseudo-random, can be set by an algorithm, or can be set by any combination of these methods.

For example, entry of the FSM may be done graphically, by text, by speech, by starting with a different FSM and modifying it, or by any other means sufficient to specify an FSM.

For example, entry of the FSM may be done on a desktop personal computer, a workstation, a handheld computer, a personal organizer, a game console, a cellphone, a custom-made FSM entry device, the controlled device itself, or any other device capable of accepting a description of an FSM from a user and capable either of sending it to another device or of using it to control itself.

For example, the input FSM can be optimized to remove unreachable states and make other improvements in such a way as to reduce the size or improve the speed of the FSM without changing the observable behavior of the controlled device.

For example, the input FSM can be stored so that it can be retrieved and viewed, edited or otherwise used at any time after it was created.

For example, the input FSM can be converted to a compiled description executable on a micro-controller running a virtual machine, to a compiled description executable on a micro-processor running an operating system, to an FPGA programming file, or to any other form capable of configuring the controlled device so that it will behave in accordance with the FSM (referred to below as a control-capable form).

For example, the FSM description may be converted to a control-capable form directly, or it may first be converted to any number and/or sequence of intermediate forms before the control-capable form is generated.

For example, any form conversion may be done on the entry device, the controlled device, or any intermediate device capable of performing the conversion.

For example, the FSM description, the control-capable form or any intermediate forms can be sent from one device to another device using removable media such as a floppy disk, audible sound, ultrasound, cables, infrared, radio or any other physical means for conveying information from one device to another.

For example, the protocol for conveying information from one device to another may be USB, Ethernet, Bluetooth, or any other protocol capable of conveying that amount of information.

For example, the control-capable form can be stored in the controlled device in RAM, in EEPROM, on a hard disk, or in any other media capable of recording the compiled description and making it available to the rest of the controlled device so that it can be used to control the controlled device.

Accordingly, the scope of the invention should be determined not by the preferred embodiment illustrated, but by the claims and their legal equivalents.

What is claimed is

1. A method of programming a device, comprising:
(a) providing an input means which a human operator can use to enter a specification of desired behavior of said device as a finite state machine description;
(b)converting said finite state machine description to a program which said device can execute;
(c) sending said program to said device, if said input means is not running on said device ; and
(d) storing said program in said device, said program being thereby enabled to control said device in accordance with said finite state machine description;
whereby a person who is not familiar with software or hardware control technology can easily program a device to behave as desired.

2. The method of programming a device of claim 1, wherein said input means displays a plurality of graphical objects on a display and enables said human operator to manipulate said graphical objects to enter all or part of said finite state machine description.

3. The method of programming a device of claim 1, wherein said human operator is a user of said device.

4. The method of programming a device of claim 1, wherein said device is a consumer product.

5. The method of programming a device of claim 1, wherein said device is a toy.

6. The method of programming a device of claim 2, wherein said human operator is a user of said device.

7. The method of programming a device of claim 6, wherein said device is a consumer product.

8. The method of programming a consumer product of claim 7, wherein said consumer product is a toy.

9. An apparatus for programming a device, comprising:
(a) an input means which a human operator can use to enter a specification of desired behavior of said device as a finite state machine description;
(b) a conversion means which will convert said finite state machine description to a program which said device can execute;
(c) a transmission means for sending said program to said device, if said input means is not running on said device; and
(d) a storage means for storing said program in said device, said program being thereby enabled to control said device in accordance with said finite state machine description;
whereby a person who is not familiar with software or hardware control technology can easily program a device to behave as desired.

10. The apparatus for programming a device of claim 9, wherein said input means displays a plurality of graphical objects on a display and enables said human operator to manipulate said graphical objects to enter all or part of said finite state machine description.

11. The apparatus for programming a device of claim 9, wherein said human operator is a user of said device.

12. The apparatus for programming a device of claim 9, wherein said device is a consumer product.

13. The apparatus for programming a device of claim 9, wherein said consumer product is a toy.

14. The apparatus for programming a device of claim 10, wherein said human operator is a user of said device.

15. The apparatus for programming a device of claim 14, wherein said device is a consumer product.

16. The apparatus for programming a consumer product of claim 15, wherein said consumer product is a toy.

17. A system for programming a device, comprising:
(a) an input means which a human operator can use to enter a specification of desired behavior of said device as a finite state machine description;
(b) a conversion means which will convert said finite state machine description to a program which said device can execute;
(c) a transmission means for sending said program to said device, if said input means is not running on said device ; and
(d) a storage means for storing said program in said device, said program being thereby enabled to control said device in accordance with said finite state machine description;
whereby a person who is not familiar with software or hardware control technology can easily program a device to behave as desired.

18. The system for programming a device of claim 17, wherein said input means displays a plurality of graphical objects on a display and enables said human operator to manipulate said graphical objects to enter all or part of said finite state machine description.

19. The system for programming a device of claim 17, wherein said human operator is a user of said device.

20. The system for programming a device of claim 17, wherein said device is a consumer product.

21. The system for programming a device of claim 17, wherein said consumer product is a toy.

22. The system for programming a device of claim 18, wherein said human operator is a user of said device.

23. The system for programming a device of claim 22, wherein said device is a consumer product.

24. The system for programming a consumer product of claim 23, wherein said consumer product is a toy.
